(19) United States
(12) Patent Application Publication
(10) Pub. No.: US 2006/0020548 A1
(43) Pub. Date: Jan. 26, 2006

(54) Interactive media viewer system with interactive email and purchase follow up capabilities and special security features

(76) Inventor: Dave Flather, North Vancouver (CA)

Correspondence Address: Dave Flather, 835 West 20th St., North Vancouver, BC, V7P 2B5, CA

(21) Appl. No.: 10/898,702

(22) Filed: Jul. 26, 2004

(51) Int. Cl. G06F 17/60

(52) U.S. Cl. 705/51

(57) ABSTRACT

Described is a system and method whereby a person(s) viewing or experiencing a multimedia program displayed on a device such as a computer screen or television screen can interact with the program in viewing environments including but not limited to: Internet type connections, telecommunication (telephone, ISDN, ADSL), VSAT satellite, and other wire and wireless transmission including as well as video conferencing. The goal of the interaction is to provide a useful and minimally interruptive form of advertising, enacting the sale of a product or service or communicating information in a synchronized manner that may or may not relate to the media being played. The interaction can take the form of a follow up email containing a special offer or information, or the interaction can even prompt the person(s) to initiate a purchase process for a good or service being promoted in conjunction with the media program. In other embodiments, viewers may interact with a given program by means of a plurality of options that include but are not limited to selecting an icon or banner or pressing a button on a remote control. The resulting action sequence will then be initiated, be it a request for information, a purchase activity and so on. If it is a purchase action that is initiated, we have enhanced the method of existing protected media delivery systems to include special security features that are designed to reduce and eliminate copying of protected multimedia programs.

### REFERENCES OF PATENTS WITH RELATED TOPICS

U.S. Pat. No. 6,606,745

U.S. Pat. No. 6,766,524

U.S. Pat. No. 6,604,085

U.S. Pat. No. 6,633,850

### BACKGROUND OF THE INVENTION

The growth of the Internet and media compression technologies have now made it possible to offer multimedia programs through the Internet or via other electronic means in a fast, affordable and high quality fashion. With the introduction of multimedia programming over the Internet, comes the capabilities for 2-way communication. This allows us to now program interactive marketing right into programs that can be used to facilitate a more useful transfer of information. This also gives us the capability to purchase things right out of multimedia programs or commercials. Thus, the advertising sector stands to benefit from our developments and ways of improving communication with individuals.

There has been a big hurdle for most owners of multimedia content such as movies etc. That has been how to allow their programs to be shown via 2-way electronic viewing without the users copying the content for resale or to avert paying for protected content. Digital Rights Management programs have been introduced and do a very effective job of limiting copying of protected content. Our method of encoding sensitive information relating to the individual takes this protection technology even further as it is aimed at creating a disincentive to an individual attempting to infringe copyrights.

### BRIEF SUMMARY OF THE INVENTION

We have utilized existing multimedia and Internet technologies and modified them and improved them to offer a secure and copyright friendly way of providing media and information in a convenient manner for the user. We have addressed many content owners copyright concerns by adding special features incorporating commercially available digital rights management technologies that prevent copying and at the same time provide disincentives for users to copy or pirate the content.

We have also developed a user initiated interactive component that when initiated by the user, can perform a plurality of duties including but not limited to automatically sending the user a follow up email, product in the mail etc. without interruption to the user's experience. This can be a non-obtrusive, non-offensive way of supplying the user additional related information or information relating to non-related topics that may be of interest to the user. Similarly, the system can be used to offer a product for sale related to the multimedia program. In this instance, the system prompts the user to initiate a purchase action that can incorporate information already accessible about the user and needed for a purchase transaction. This can greatly streamline the electronic purchase of a good or service, as the user may not have to enter any of their personal information details, as that can be accessed in a database if the person is viewing the media in a logged in environment or in an environment where an account has been previously established, such as in the instance of a cable television, telephone service wired or wireless) or Internet service providing environment.

A working Interactive Media Viewer System has been built and successfully tested under a host of scenarios. This is evidenced by references to a testing web site relating to bike films.

### BRIEF DESCRIPTION OF THE DRAWINGS

FIG. 1: Interactive Media Viewer mockup.

FIG. 1 clearly shows the controls in the center at the bottom that the user can use to play, pause, stop and adjust the audio of the media with. As well, the “Banner 1” and “Banner 2” images show a possible location of where the special graphics or text can be located that when interacted with by the user, will initiate a follow up action.

This viewer will auto-detect the users screen settings and maximize accordingly.

The media images may or may not be in proportion to that shown.

FIG. 2) Interactive Media Viewer with initial banner message

FIG. 2 shows an Internet enabled browser window with the Interactive Media Viewer embedded within the browser window. It also depicts that the page is personalized and has the capabilities to reference details about the user. It also depicts a preliminary message that can be displayed that will solicit and initiate the user interaction.

FIG. 3) Interactive Media Viewer with second message

FIG. 3 shows an example of a second message displayed, with a personalized link embedded in the banner.

FIG. 4) Database table with sample customer or user data:

FIG. 4 depicts an example of a database table with possible customer data containing just 3 possible elements of the data set.

FIG. 5: Possible log in page mockup depicting the user's requirement to enter 2 pieces of data related to the “data set” supplied or acquired either in some form of sign up process or purchase process.

As shown, the user is asked to supply his postal code and last 4 digits of his credit card. 2 elements of the data set guaranteed to generate a unique “data packet” are email address and elements pertaining to the data of the credit card or bankcard.

### DETAILED DESCRIPTION

Overview

The Interactive Media Viewer System can be described as a system operating in a 2-way electronic communication environment capable of displaying multimedia or audio/visual content. In applications such as a computer/Internet connection environment, we have developed a means by which the user watching a multimedia audio/visual program can interact with specially programmed marketing, advertising, informational or purchase related messages or icons to obtain information on a topic of interest or to obtain more information on a topic of interest that may be shown in the multimedia program. This is facilitated through a specially programmed “media player” capable of incorporating detailed programming and skins or layers of information or programmed features. The user may use any number of means or devices available to him to initiate the interaction. Such devices include but are not limited to a computer mouse, pointing device, keyboard or even voice recognition interface.

The Interactive Media Viewer System can also be used to solicit a purchase of a physical or electronic product or service. This can be done with the Interactive Media Viewer System in environments where a user has performed some form of login process but may also include but is not limited to environments where a user may be utilizing a connection obtained from a pre-arranged membership or service agreement that incorporates a database of payment information relating to the account of the user. A few examples of such instances could be a cable television connection, a telephone service account or an Internet service account. In these cases, the interactive media viewer system is connected to a database of the connection service account that contains details about the user. These details are then accessed by the media viewer, which are then used to both process payment for the selected purchase as well as complete the shipping information.

In instances where the owner of copyright protected multimedia content wish to further reduce the incidence or incentives of individuals infringing upon their copyrights over and above the protections offered by commercially available Digital Rights Management processes, we have also developed a method whereby we can encrypt into the multimedia itself and/or the digital rights license (the digital rights license may form a separate but integral and necessary component to view the media) data elements relating to the payment information of a user. This serves as a deterrent for individuals to copy and distribute the content to 3^{rd} parties, as they could potentially compromise their payment or credit information.

### DETAILED DESCRIPTION

Specifics

The Interactive Media Viewer can be a programmed screen compatible with but not limited to Internet Explorer versions 4 and higher as well as the next 2 most popular Internet Browser platforms. The Interactive Media Viewer may also be incorporated with other media technologies capable of 2-way data or information transfer.

The Interactive Media Viewer may be deployed with existing electronic media player technology or new technologies with similar or improved capabilities.

The Interactive Media Viewer system is able to stream the video and audio files of programs of any length seamlessly and without interruption on the typical Internet connection, cable television connection, or telecommunication connection. The system is geared towards high-speed cable and DSL Internet users, and will be useable for lower speed dial-up connections as well. The Internet connection can be comprised of the following forms but is not limited to them: Internet type connections, telecommunications (telephone, ISDN, ADSL), VSAT satellite, other wire and wireless transmission and video conferencing.

The media/content provided by the Interactive Media Viewer system will be copy protected so as to not easily be copied by the end user. The media may be protected in several ways by the processes and programs deployed in the system. First, commonly accepted “Digital Rights Management” protocols may be deployed which issue and deliver licenses integral to the playing of the media. Alternatively, the media may be buffered with a new file extension not recognizable by most computers (the media does not go to a temporary file or folder on the users peripheral device). A special “copy deterrent” process can also be enacted whereby a user's personal information is encoded into the product or service for electronic delivery. This personal information could include any element or combination of elements of the “data set”, being the information collected or acquired during a sign up, electronic purchase process or part of a pre-existing membership or subscription service. This process is enacted for the sole purpose of ensuring that purchasers of protected or copyable electronic products or information do not copy them and forward them on to 3^{rd} parties that did not pay for the product, information or service. This media protection can also apply so that only allowed “classes” of users are able to access the media. Class distinction may be based on any variable imaginable, including but not limited to age, security clearance and so on.

The media delivered with the Interactive Media Viewer may be informational, promotional, entertainment oriented or otherwise.

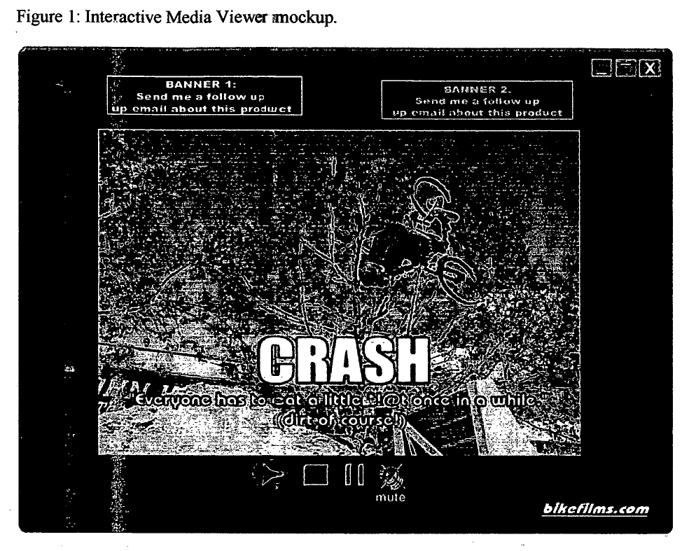

The Interactive Media Viewer is able to auto-detect and resize to maximize the viewing area on the different screen settings of the user's peripheral device or screen. The user is also able to shrink down the media viewer. See FIG. 1.

The Interactive Media Viewer is capable of offering television broadcast quality imaging and audio, as well as higher and lower quality levels that will be permitted by the type of connection utilized as well as the type of peripheral device displaying the media.

The Interactive Media Viewer envisioned in the drawing labeled FIG. 1 of this invention has the capability to request a follow up email or some other form of follow up/messaging based on a banner, logo or some form of text message displayed within the Interactive Media Viewer browser or through the use of an audio command coinciding with some form of visual or auditory prompt. When the user selects this with an input device such as a mouse or remote control button, or interacts with this special banner or message, their viewing may or may not be interrupted (non-interrupting is preferred), rather a follow up message in text or HTML form or other written or electronic form will be sent and delivered to their email address or home address corresponding with the information stored in an electronic form and tied into the media player and the user's identification or pre-existing service account or membership. The system can also generate and send a facsimile if a valid fax number is included in the data set of the user. Simple logic rules may also be deployed in the system so that for instance a primary source of communication would be email, then if no valid email address were located, a second preference for information or product delivery may be facsimile and so on.

The Interactive Media Viewer system also has the capability to prepare a purchase or sale receipt and a packing slip for a physical product that may need physical delivery as a result of a purchase using the Interactive Media Viewer system. The Interactive Media Viewer system is also capable of initiating an electronic delivery of an electronic product, application or service. The Interactive Media Viewer can have several separate banner slots in the Interactive Media Viewer screen that can easily be synchronized with related media throughout the viewing session. This is explained in the programming source code portion of this patent in B.) below. There exists a module in the Interactive Media Viewer server's database to program the banner or message to show, the length to show it and the interactive action, process or message to send via email or some other form of delivery including but not limited to mail, courier or fax referencing the database purchase information provided by the user or details provided by the user. The Interactive Media Viewer System has the ability to program and store any number of programmed messages and/or interactive actions.

This process is clearly documented below, with reference to figures as noted.

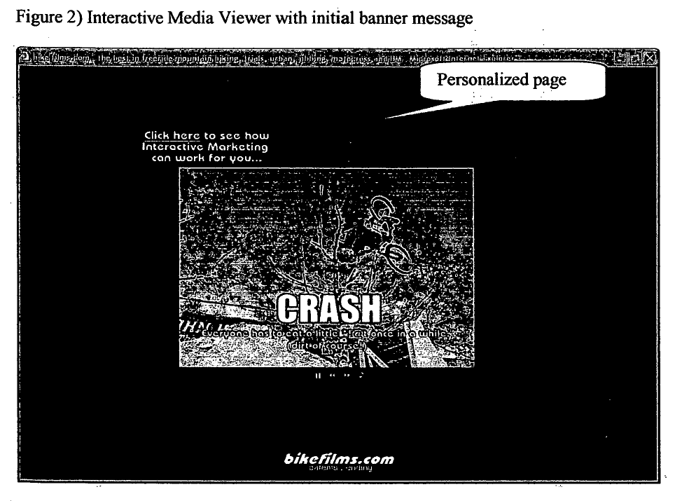

A.) The initial banner message solicits the user to initiate a response, which in this example is to use their pointing device to click on the banner. This will also work with touch-screen technology as well as auditory command recognition devices. Please see the drawing in FIG. 2 for a visual representation.

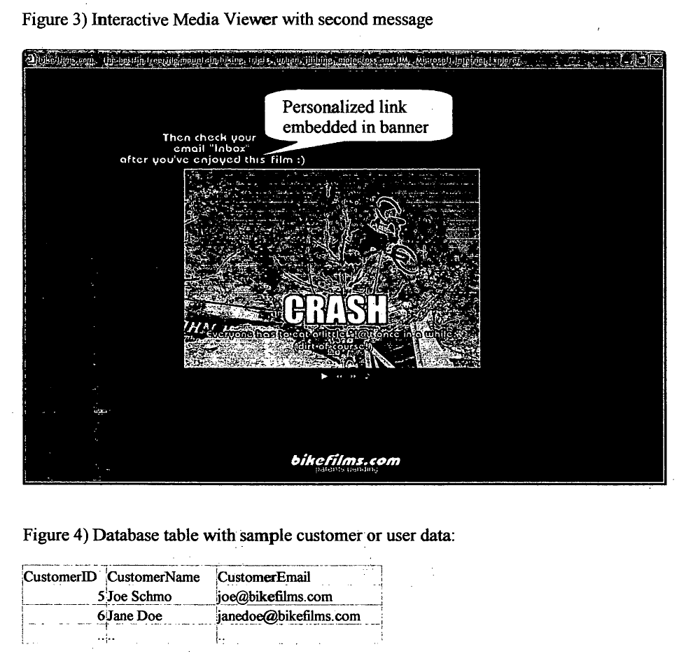

The second message as shown in the drawing of FIG. 3 explains to the user what to do or what to expect after the solicited interaction with the Interactive Media Viewer takes place.

B.) The following information depicts the source code from the viewer diagrams depicted in drawings titled FIG. 2 and FIG. 3.

<html><HEAD><script language=JavaScript>
// hide scroll-bars
//document.body.scroll = “no”; replaced by body scroll=no
</script>
<TITLE>bike films.com - the best in freeride mountain biking, trials, urban, jibbing, motocross and BMX.</TITLE>
<link rel=“stylesheet” type=“text/css” href=“/bf/bf.css” title=“style1”>
<script language=“Javascript”>
<!--
var has_played = false;
var curmode = “play”;
var pause_flag = 0;
var play_flag = 1;
var mute_flag = 0;
var reverse_flag = 0,
var forword_flag = 0;
var vol_flag = 50;
var Tstatus = 0;
var Mstatus = 0;
var Hstatus = 0;
var timer_id;
var intBanner1ID = “none”;
var intBanner2ID = “none”;
var ff_active = false;
var ff_active_time = 0;
var image1x1 = new Image( );
image1x1.src = “http://www.bikefilms.com/images/1x1.gif”;

| | |
|---|---|
| java3 | = “false”; |
| browserVer | = parseInt(navigator.appVersion); |

```
browserName = navigator.appName;
var banner_actions = new Array( new Array( ‘banner1’, new Array( new Array(
65,‘http://www.bikefilm.com/300x60_Interactivebanners/advertisers_300x60animated.gif’,30,new Image( ) ), new Array(
110,‘http://www.bikefilm.com/300x60_Interactivebanners/300x60_transparent_bikefilms_banner.gif’,−1,new Image( ) ) ), −1 ), new
Array( ‘banner2’, new Array( new Array(
140,‘http://www.bikefilm.com/300x60_Interactivebanners/Rohloff_300x60animated.gif’,21,new Image( ) ), new Array(
200,‘http://www.bikefilm.com/300x60_Interactivebanners/300x60_transparent_bikefilms_banner.gif’,−1,new Image( ) ) ), −1) );
var current_banner = new Array( )
function banner_clicked( banner_spot ){
  var q, banner_index;
  for (q=0;q<banner_actions.length;q++) {
    if (banner_spot==banner_actions[g][0]) { // we found the banner definition
      banner_index = banner_actions[q][2]; // this banner is currently displayed
      if (banner_index>=0) {
        if (banner_actions[q][1][banner_index][2]!=−1) { // there is a real mail action associated
with the banner
          document.action_img.src = ‘http://www.bikefilms.com/bf/’ +
            ‘send_banner_email.asp?profile_id=5&id=’ +
            banner_actions[q][1][banner_index][2];
          //alert( banner_spot + ‘clicked, sending e-mail...’);
        }
      }
    }
  }
}
function maximize_window( ) {
  window.moveTo(0,0);
  if (document.all) {
    top.window.resizeTo(screen.availWidth,screen.availHeight);
  } else if (document.layers∥document.getElementById) {
    if (top.window.outerHeight<screen.availHeight∥top.window.outerWidth<screen.availWidth) {
      top.window.outerHeight = screen.availHeight;
      top.window.outerWidth = screen.availWidth;
    }
  }
}
if (browserName == “Netscape” && browserVer >= 3 ∥ browserName == “Microsoft Internet Explorer” && browserVer >= 4) {
  java3 = “true”;
}
function change(Name, Mode) {
  if (java3 = “true”){
    //document [Name].src = eval(Name + Mode + “.src”);
  }
}
function set_looping( new_value ) {
  //document.MediaPlayer.settings.setMode( “loop”, new_value );
}
function button_clicked( operator ){
    if (operator == “pause_play”) {
      set_looping( false );
      if (MediaPlayer.playState==3) { // playing
        document.MediaPlayer.controls.Pause( );
      } else {
        document.MediaPlayer.controls.Play( );
      }
      ff_active = false;
    } else if (operator == “stop”) {
      set_looping( false );
      if (document.MediaPlayer.controls.isAvailable(‘CurrentPosition’)){
  document.MediaPlayer.controls.currentPosition = 0;
      }
      document.MediaPlayer.controls.Stop( );
      ff_active = false;
    } else if (operator == “fastforward”) {
      if (MediaPlayer.controls.isAvailable(‘FastForward’)) {
        set_looping( true );
        document.MediaPlayer.controls.FastForward( );
        ff_active = true;
        ff_active_time = 0;
      }
    } else if (operator == “fastrewind”) {
      if (MediaPlayer.controls.isAvailable(‘FastReverse’)) {
        set_looping( true );
        document.MediaPlayer.controls.FastReverse( );
      }
      ff_active = false;
    } else if (operator == “mute”) {
      MediaPlayer.settings.mute = ! MediaPlayer.settings.mute;
    }
}
function refresh_banners( ) {
  // get current position in seconds
  var player_position = document.MediaPlayer.controls.currentPosition;
  // show current position for testing
  //document.all[‘title2’].innerHTML = document.MediaPlayer.controls.currentPositionstring;
  // lookup banner that should be displayed right now
  var q, w;
  var banner_index;
  for (q=0;q<banner_actions.length;q++) {
    banner_index = −1;
    for (w=0;w<banner_actions[q][1].length && banner_index==−1;w++) {
      if (player_position>=banner_actions[q][1][w][0]) {
        if (w==banner_actions[q][1].length−1) { // we are past the last action
          banner_index = w;
        } else if (player_position<=banner_actions[q][1][w+1][0]) {
          banner_index = w;
        }
      }
    }
    if (banner_index>=0) {
      // if a different banner is displayed, switch
      if (banner_index!=banner_actions[q][2]) {
        banner_actions[q][2] = banner_index;
        if (banner_actions[q][1][banner_index][1]==‘clear’) {
          document[ banner_actions[q][0] ].src = image1x1.src;
        } else {
          document[ banner_actions[q][0] ].src =
banner_actions[q][1][banner_index][3].src;
        }
      }
    }
  }
  if (ff_active) { // stops Fast Forward from going all the way to the end, stops after 15 seconds of forwarding
    ff_active_time++;
    if (ff_active_time>=15) {
      button_clicked(“pause_play”);
    }
  }
  timer_id = setTimeout(“refresh_banners( )”,1000); // check on position again in 1 second (position may change because of
FF/REW/Play)
}
function initialize( ) {
  maximize_window( );
  // preload images
  var q, w;
  for (q=0;q<banner_actions.length;q++) {
    banner_index = −1;
    for (w=0;w<banner_actions[q][1].length;w++) {
      if (banner_actions[q][1][w][1]!=“ && banner_actions[q][1][w][1]!=‘clear’) {
        banner_actions[q][1][w][3].src = banner_actions[q][1][w][1]; // pre-load image
      }
    }
  }
  timer_id = setTimeout(“refresh_banners( )”,1000);
  MediaPlayer.controls.Play( );
}
//-->
</script>
</HEAD>
<BODY scroll=“no” bgcolor=“black” onLoad=“initialize( )” topmargin=“0” leftmargin=“0”>
<table border=“0” cellspacing=“0” cellpadding=“0” width=100% height=100%>
<tr><td valign=center align=center>
    <table border=“0” cellspacing=“0” cellpadding=“0” width=720>
      <tr><td align=center>
        <table width=720 border=0 cellspacing=0 cellpadding=0><tr><td width=300><a
href=“#” onClick=“banner_clicked(‘banner1’); return false”><img id=banner1 name=banner1 alt=“” src=“../images/1x1.gif”
width=300 height=60 border=0></a></td>
        <td><img src=“/images/1x1.gif” width=−120 height=1><br><img id=action_img
name=action_img src=/images/1x1.gif width=1 height=1></td>
        <td width=300><a href=“#” onCick=“banner_clicked(‘banner2’); return false”><img
id=banner2 name=banner2 alt=“” src=“../images/1x1.gif” width=300 height=60 border=0></a></td></tr></table>
      </td></tr>
      <tr><td><img src=“/images/1x1.gif” width=1 height=5></td></tr>
      <tr><td align=center>
        <OBJECT style2=“cursor:hand” id=MediaPlayer width=480 height=320
          classid=CLSID:6BF52A52-394A-11d3-B153-00C04F79FAA6
STANDBY=“Loading Windows Media Player components...”
            TYPE=“application/x-oleobject”
  CODEBASE=“http://activex.microsoft.com/activex/controls/mplayer/en/nsmp2inf.cab#Version=6,4,7,1112”>
    <param name=“URL” value=“http:/www.esgi.ca/bikefilmsdotcom_files/videos/CRASHFREETRIAL.wmv”>
    <param name=“rate” value=“1”>
    <param name=“balance” value=“0”>
    <param name=“currentPosition” value=“0”>
    <param name=“defaultFrame” value>
    <param name=“playCount” value=“1”>
    <param name=“autoStart” value=“0”>
    <param name=“currentMarker” value“0”>
    <param name=“invokeURLs” value=“−1”>
    <param name=“baseURL” value>
    <param name=“volume” value=“50”>
    <param name=“mute” value=“0”>
    <param name=“uiMode” value=“none”>
    <param name=“stretchToFit” value=“−1”>
    <param name=“windowless Video” value=“0”>
    <param name=“enabled” value=“−1”>
    <param name=“enableContextMenu” value=“−1”>
    <param name=“fullScreen” value=“0”>
    <param name=“SAMIStyle” value>
    <param name=“SAMILang” value>
    <param name=“SAMIFilename” value>
    <param name=“captioningID” value>
    <param name=“enableErrorDialogs” value=“0”>
    <param name=“_cx” value=“19050”>
    <param name=“_cy” value=“12700”><embed TYPE=“application/x-mplayer2”
SRC=“htp:/www.esgi.ca/bikefilmsdotcom_files/videos/CRASHFREETRIAL.wmv” NAME=“MediaPlayer” Width=“720”
HEIGHT=“480”>
      </OBJECT></td></tr>
    <tr><td align=center colspan=1><DIV id=title2 style=“color: white”>Buffering Movie</DIV></td></tr>
    <tr><td align=center colspan=1><a href=“#” onClick=“button_clicked(‘pause_play’); return false;”><img
alt=“Play/Pause” name=pause src=“/images/viewer/pause_off_yellow.gif” height=23 width=23 border=0 alt=“”></a><a href=“#”
onClick=“button_clicked(‘fastrewind’); return false;”><img alt=“REW” name=fastrewind src=“/images/viewer/rw_off_yellow.gif”
height=23 width=23 border=0></a><a href=“#” onClick=“button_clicked(‘fastforward’); return false;”><img alt=“FF”
name=fastforward src=“/images/viewer/ff_off_yellow.gif” height=23 width=23 border=0></a><a href=“#”
onClick=“button_clicked(‘mute’); return false;”><img alt=“Mute” name=mute src=“images/viewer/mute_off_yellow.gif” height=23
width=23 border=0></a></td</tr>
    </table>
  </td></tr>
  <tr><td align=center><img src=“images/viewer/bikefilmsdotcom_logo_patentspending.gif”></td></tr>
<table>
<SCRIPT for=“MediaPlayer” event=“playStateChange(NewState)” LANGUAGE=“JScript”><!--
switch (NewState) {
  case 1: // stopped
  document[“pause”].src = “/images/viewer/play_off_yellow.gif”;
  if (has_played) {
    alert(‘Thank you for watching.\n\nThis window will now close.’);
      window.close( );
    }
  break;
  case 2: // paused
  document[“pause”].src = “/images/viewer/play_off_yellow.gif”;
  break;
  case 3: // playing
  document[“pause”].src =“/images/viewer/pause_off_yellow.gif”;
    document.all[‘title2’].innerHTML = “”;
    has_played = true;
  break;
  case 6: // buffering
    document.all[‘title2’].innerHTML = “Buffering Movie”;
  break;
  default: // rewind/forward and possibly others
  document[“pause”].src = “/images/viewer/play_off_yellow.gif”;
  break;
}
--></Script>
<SCRIPT for=“MediaPlayer” event=“Buffering(Start)” LANGUAGE=“JScript”><!--
--></Script>
<SCRIPT for=“MediaPlayer” event=“MarkerHit(MarkerNum)” LANGUAGE=“JScript”><!--
  document.banner1.src = “/banners/New_Segments_banner5.png”;
//  document.banner2.src  = “/banners/Rohloff_banner1.png”
//  alert( MarkerNum );
  if (MarkerNum>=1 && MarkerNum<=4) {
  document.banner2.src = “/banners/Rohloff_banner”+MarkerNum+“.png”;
  }
--></Script>
<SCRIPT for=“MediaPlayer” event=“Click(nButton, nShiftState, fX, fY)” LANGUAGE=“JScript”><!--
  //if (nButton==1) {
  //  alert( “Left-click at [ “ + fX + ”, “ + fY + ” ]” );
  //}
--></Script>
<SCRIPT for=“MediaPlayer” event=“MouseMove(nButton, nShiftState, fX, fY)” LANGUAGE=“JScript”><!--
  //MediaPlayer.style.cursor=“hand”;
  //document.MousePointer = (fX > 200) ? 11 : 0;
--></Script>
</BODY>
```

C.) The following code depicts the script initiated by clicking on a personalized link within the interactive media viewer that results in the user receiving the requested information:

(Note: See inline comments for process description)

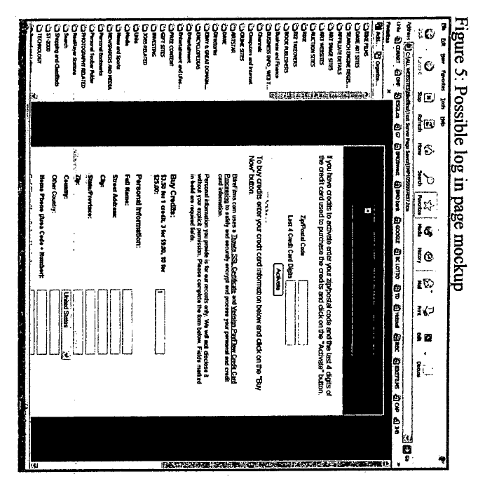

```
send_banner_email.asp:
<!--#INCLUDE FILE=“library.asp”--><%
  init
  make_log_entry “sending banner email”
  dim profile
  set profile = new cProfile
  ‘retrieve customer information from database, based on GET
  parameter “profile_id”
  ‘see Figure 4 for sample database structure
  profile.Load request(“profile_id”)
  dim message
  set message = new cMessage
  ‘send message to the customer, the message to be sent is
  ‘identified by the GET parameter “id”
  call message.Send( profile.get_attribute(“id”), CInt(request(“id”)) )
  ‘return a transparent 1-pixel image to the browser so the interaction
  ‘doesn't have any impact on the user experience when viewing video
  Response.Redirect “/images/1x1.gif”
%>
```

D.) The following is an example of an “HTTP GET” request initiated by clicking on a banner:
http://www.bikefilms.com/bf/send_banner_email.asp?profile_id=5&id=2

E.) Interactive Media Viewer system user interaction process description:
1) Banner images are alternated on a page (FIGS. 2 & 3) in a pre-programmed sequence by use of JavaScript (for page source see “B.)” above)
2) The JavaScript code remembers which banner image is currently displayed
3) When user clicks on a banner image, the JavaScript constructs a URL (see “D.)” above) and assigns it as a source of one 1-pixel image on the page. This initiates an HTTP GET request to the bikefilms.com server and runs the script from “C.)”. The script returns a reference to a 1-pixel transparent image which is loaded into the page, this is however undetectable by the user.

F.) FIG. 4) depicts an example of a database table with user or customer data. These key fields are used in the Interactive Media Viewer system in conjunction with an information repository, database or “cookie” to serve up the elicited response to the correct user.

G.) The viewer can have a similar look to that as shown in FIG. 1, FIG. 2 or FIG. 3. The interactive areas of the Interactive Media Viewer can even be programmed so that areas of the actual media may serve as a “hot spot” containing a personalized link created in a layer overlaid over the multimedia or static image. A plurality of “hot spots” or “hot linked” layers can be deployed at any time during the viewing.

H.) A second Interactive Media Viewer can be deployed if users buy or download segments on to their computer for viewing at anytime. If this is done, the Interactive Media Viewer System will have the exact same functionality as the Interactive Media Viewer system described above, including the capability of an interactive banner function. The user will be given the opportunity to use fast forward and rewind buttons. Through some form of cookie or electronically stored data residing on the user's computer and/or the server, the viewer will be able to run and show synchronized banners that will initiate a some follow up email or some form of message, product delivery or interaction when interacted with the user or initiated by the user. For commands requiring information requests be sent externally from the peripheral or multimedia device, some form of electronic connection capable of data transfer to a service provider may be necessary. Examples of service providers can be but are not limited to cable television service, telephone service or Internet services.

I.) Users of the Interactive Media Viewer system may be given the option to “view now” or “view later”. If they choose view now, the Interactive Media Viewer will start immediately. If they choose view later, they will be instructed on how to view later. If the user is using an Internet enabled Interactive Media Viewer to view the media later, the user will then be prompted to a “login” page. The user will be asked to submit “1 or more pieces of information” relating to the “data set”—being the information supplied in the purchase process or during some login or signup process. This may be the zip code and last 4 digits of the credit card used for purchasing credits or even their email address. This will log them in and they will be able to select the product purchased. This process is certain to generate a unique login and prevents the need for the user to remember some unknown, auto-generated password. This is much easier for the user, as he simply enters data already familiar to him used in the purchase process. However, in some instances, managers of the Interactive Media Viewer System may opt for some auto-generated password, such as when users are not of sufficient age to possess a credit card.

In addition, some applications may wish to generate unique numeric, alphabet-based or alphanumeric passwords for security reasons.

Definition Notes:

Note: credit card, bankcard or card used for electronic transactions can be used interchangeably.

Note: The data set can refer to but is not limited to the following common informational items supplied or acquired about the user or individual:
Name,
Address,
Email address
Phone/fax numbers
Postal code
City or country
Credit card number
Credit card expiry date
Security numbers on credit card
IP address of host or client computer
Web site address where transaction is taking place
Time and or date stamp at time of transaction

Note: “Data packet” can refer to any individual item or combination of items in whole or in part contained within the data set.

Note: Internet can also be used interchangeably with “any means of electronic delivery” and can include but is not limited to telephone communication or broadcast media including but not limited to cable television or satellite or radio wave delivered media.

Note: Internet and web can be used interchangeably.

Note: product, service, information and entertainment are all phrases that may be used interchangeably or together.

Note: “hot spot” or “hot linked” refers to an area or layer on a page, image or screen that can contain a transparent hyperlink or programmed script that when activated by an action such as clicking on it, will take the user to a new screen or perform some other task.

Date of First Discovery:

The proprietary processes utilized in this specification were first devised Sep. 24, 2002 by David Flather. Subsequent electronic documents were produced with actual detailed specifications Dec. 26, 2002.

A provisional patent application was made and received by the USPTO on Aug. 12, 2003.

I seek Patent protection on:

1. The method whereby a user interacts with some form of electronic or graphical message displayed in conjunction with viewing media being delivered electronically and played on their computer, television or other peripheral device, be it wired or wireless, that will initiate an a non-interrupting action (or interrupting action) such as a follow up email or message delivered electronically or some product delivered electronically, physically by mail or otherwise. The message or product could be informational, entertainment related, promotional or otherwise. An actual product could even be purchased as a result of the interaction, as the interaction will be facilitated using information already obtained by the user in a sign up procedure, purchase procedure, or as part of a pre-existing membership or subscriber service paid or otherwise. That data is stored electronically through a database, electronic cookie or otherwise and utilized to follow up the specified action with the corresponding user.

2. The method of whereby a user interacts with voice commands to an electronic display, graphical message or sound prompt created or displayed in conjunction with viewing media being delivered electronically and played on their computer, television or other peripheral device, that will initiate an action such as a follow up email or message delivered electronically or some physical product delivered otherwise. The interaction can be facilitated discretely without interruption of the media, or the media being played may automatically be paused. The interactive message or sound prompt could be informational, entertainment related, promotional or otherwise. An actual product could even be purchased as a result of the interaction, as the interaction may be facilitated using information already obtained by the user in a sign up or purchase procedure or otherwise. That data may be stored electronically and utilized to follow up the specified action with the corresponding user. The multimedia device that is used to display the media must be capable of at least receiving auditory signals and may have a speaker that can create sounds (as well as sound prompts) and a microphone that can accept and recognize auditory commands made by the user.

3. The method of whereby key details of an electronic purchase, sign up process or pre-existing membership or subscriber service are combined to create a unique “identifier” that can be used as a unique password or login key for a customer. The combination may include but is not limited to elements of the data set that can include: Full or part name, full or part address, full or part postal code/zip, full or part of their email address, full or part of the details on their credit card or electronic bank card including the card number, the expiry date of the card, the name as it appears on the card, the billing details of the card or other security feature of the card that only someone with the card in their possession may know (such as security code numbers listed on the back of the card). When this data is acquired or entered, an electronic process follows a set of rules and combines part or all of 1 or more elements of the data set to form a truly unique “data packet”. This data packet is then referenced when a user tries to access their product, service or information, and unless an exact match is made with the user's input data and the data packet, the user will not be allowed access to the product, information or service.

4. The method whereby a user's personal information is encoded into a product or service for electronic delivery. This personal information could include any element or combination of elements of the “data set”, being the information collected or acquired during a sign up, electronic purchase process or derived from some form of pre-existing membership or subscription service arrangement. This process is enacted for the purpose of ensuring that purchasers of protected or copyable electronic products or information do not copy them and forward them on to 3^{rd} parties that did not pay for the product, information or service.

5. The system whereby interactive banners or messages mentioned in claim 1 perform the desired functions as requested by the user.

6. The method whereby interactive banners or messages mentioned in claim 1 perform the desired functions as requested by the user.

7. The method whereby the interaction by the user in claim 1 is initiated with the use of an input device such as a computer keyboard.

8. The method whereby the interaction by the user in claim 1 is initiated with the use of an input device such as computer mouse or other pointing device.

9. The method whereby the interaction by the user in claim 1 is initiated with the use of an input device such as button located on a wired or wireless remote control device.

10. The method whereby the interaction by the user in claim 1 is initiated with the use of an input device such as a microphone capable of accepting auditory signals or prompts.

11. The method whereby the interaction by the user in claim 1 is initiated with the use of an input device such as touch-sensitive interface.

12. The method whereby the interaction by the user in claim 1 is initiated with the use of an input device such as an infrared signal or beacon or a laser beam emanating from a wired or wireless remote control device.

13. The method whereby the interaction by the user in claim 1 is initiated by motion of the user.

14. The method whereby the interaction by the user is facilitated (but is not limited to) the following types of electronic environments: Internet type connections, telecommunication (telephone, ISDN, ADSL), VSAT satellite, and other wire and wireless transmission including video conferencing.
